(19) United States
(12) Patent Application Publication
(10) Pub. No.: US 2006/0247046 A1
(43) Pub. Date: Nov. 2, 2006

(54) Method of synchronizing motion of cooperative game system method of realizing interaction between pluralities of cooperative game system using it and cooperative game method

(76) Inventors: Kang-in Choi, Kwacheoni-si, Kyungki-do (KR); Kuk-young Cho, Suwon-si, Kyungki-do (KR); Sung-su An, Gunpo-si, Kyungki-do (KR); Wan-Ho Jang, Kyungki-do (KR)

Correspondence Address: MAYER, BROWN, ROWE & MAW LLP, 1909 K STREET, N.W., WASHINGTON, DC, 20006, US

(21) Appl. No.: 10/565,849

(22) PCT Filed: Jul. 23, 2004
(86) PCT No.: PCT/KR04/01839

§ 371 Date: Jan. 26, 2006

(30) Foreign Application Priority Data
Jul. 26, 2003 (KR) 10-2003-0051714

(51) Int. Cl. A63F 13/00

(52) U.S. Cl. 463/36

(57) ABSTRACT

It is an object of the present invention to provide a method for synchronizing motions in a cooperative game system in which two or more motions of structures configured by input events are displayed to be integrally and simultaneously implemented in synchronization with a unit time. According to the present invention for achieving the aforementioned object, there is provided a method for synchronizing motions realized in a game system including dance games played through cooperation between players, wherein if, with respect to an event input by one player during any one of unit times when progress is repeated in synchronization with a standard time, another player inputs the same event, a unit motion corresponding to the inputted event is simultaneously represented through the structure during a subsequent unit time. According to the present invention, in three-dimensionally realized computer graphics images, free representation for structure motions is possible, as well as structure motions that consider interactions between structures having a plurality of links can be realized by simpler and easier manipulations. Further, physical characteristics similar to reality can be realized on structure motions provided through three-dimensional graphics images, and an overall structure can operate successively while maintaining natural poses.

### BACKGROUND OF THE INVENTION

1. Field of Invention

The present invention relates to a method for synchronizing motions in a cooperative game system, a method for implementing interactions between a number of cooperative game systems to which the synchronizing method is applied, and a cooperative gaming method. More particularly, the present invention relates to a method for synchronizing motions in a cooperative game system, in which structures are displayed in synchronization with a unit time so that the structures integrally and simultaneously implement one unit motion corresponding to events input by a variety of input devices in a cooperative game system including dance games, implemented in the form of a single system or a remote client system over a network; to a method for implementing interactions between a number of cooperative game systems in which a unit motion is executed in each cooperative game system by applying such a method for synchronizing motions in a cooperative game system, and at the same time, a new unit motion is displayed by synchronizing interaction motions between a number of cooperative game systems; and to a method for a cooperative game including dance games, applied with the method for implementing interactions between a number of cooperative game systems.

2. Description of the Prior Art

Generally, in computer graphics, the extraction and application of features of key portions of actual motions are needed in order to represent motions of a structure in a realistic manner, in which the structure refers to an object that balances upon realizing motions by means of joints, rotation range of joints, balance maintaining motions, and the like, such as humans or animals.

To this end, features of relevant motions of the structure should be analyzed and the weight of motions should also be specified. At this time, if there are interactions between two structures, the weight of an arbitrary motion must be recognized in a state where one structure does not know motions of the other to be executed in the future.

Therefore, there arises a problem that motions between two structures are exhibited clumsily because the weight of motions depending on interaction between the structures is not specified correctly.

To solve this problem, an inverse kinematics model and the like have been suggested which extracts and applies key motion features that are captured from inter-structure motions resulting from the interactions between the structures.

However, this inverse kinematics model method is applied only between a single structure, in which interactions between two or more structures are not considered, and the single structure.

In a case where such interactions are considered, the inverse kinematics model method cannot be applied between two or more structures because problems in predicting motions cannot be solved when interference occurs between two or more structures.

That is, with only the presently disclosed technologies other than the present invention, it is impossible to implement synchronization in which interactions between two or more structures are considered.

### SUMMARY OF THE INVENTION

The present invention is conceived to solve the aforementioned problems with the prior art. It is an object of the invention to provide a method for synchronizing motions in a cooperative game system in which two or more structure motions by input events are integrally and concurrently realized by synchronizing the motions to a unit time in a cooperative game system including dance games.

Further, it is another object of the invention to provide a method for realizing interaction between a number of cooperative game systems in which motion interactions between a number of cooperative game systems can be controlled by applying such a method for synchronizing motions in a cooperative game system, and to provide a cooperative gaming method including dance games, applied with the method for realizing interactions between a number of cooperative game systems.

According to an aspect of the present invention for achieving the aforementioned objects, there is provided a method for synchronizing motions realized in a game system including dance games played through cooperation between players, wherein: if, with respect to an event input by one player during any one of unit time when progress is repeated in synchronization with a standard time, another player inputs the same event, a unit motion corresponding to the input event is simultaneously represented through the structure during a subsequent unit time.

Preferably, the cooperative game system may be implemented in the form of a single system.

Preferably, the cooperative game system may be implemented in the form of a remote client system over a network.

Preferably, the event may be input by one or a combination of a keyboard, mouse, trackball, joystick, touch screen, cellular phone key pad, dance pad, and network interface card (NIC).

Preferably, the event may be input by a direct action input device with cameras or sensors and a voice input device such as a microphone.

Preferably, the standard time may be set as a world time code (WTC).

Preferably, the unit motion may be set while storing frame vertex positions and data that correspond to respective motion scenes and producing data through interpolation calculations.

Preferably, the unit motion may be set while dividing the structure into several substructures, defining each relationship for the substructures, and producing data by specifying data for the divided substructures every frame or varying frame.

Preferably, the unit motion may be set while producing data through movement along position values in a hierarchical structure that defines respective relationships based on structure data of a joint unit called a bone.

Preferably, the unit motion may additionally use sound and is displayed in synchronization with the sound.

Preferably, the sound may be one of WAV, MP3, WMA or MIDI format.

Preferably, the unit motion may be displayed in synchronization with a standard time in which the standard time is set in conformity with a playing time of the sound.

Preferably, the unit motion may be output and displayed via an image output device and a sound output device.

Preferably, the image output device may be any one of a monitor, a head up display device (HUD), or an LCD panel.

Preferably, the sound output device may be a speaker.

Preferably, the image output device may confirm input/output intermediation states via a solid object through transmission and reception to and from the solid object.

Further, according to another aspect of the present invention for achieving the aforementioned objects, there is provided a method for implementing interactions between a plurality of cooperative game systems generated in a course of individually realizing unit motions of each of the cooperative game systems by applying the method for synchronizing motions in the cooperative game system of claim 1, wherein: if, with respect to an event input by one player during any one of unit times when progress is repeated in synchronization with a standard time, another player inputs the same event, each of the plurality of cooperative game system realizes a unit motion corresponding to the input event through the structure during a subsequent unit time, and at the same time, allows interactions generated by an individual unit motion implemented at each cooperative game system to be represented as a new unit motion by applying the method for synchronizing motions in the cooperative game system.

Preferably, the standard time may be set as a world time code (WTC).

Preferably, the plurality of cooperative game systems may be implemented in the form of server/client by one server system and a plurality of client systems.

Preferably, the plurality of cooperative game systems may be implemented in the form of peer to peer by a plurality of client systems.

Preferably, the peer-to-peer form may be serviced via one or a combination of information sharing types and resource sharing types.

Preferably, the peer to peer form may use one or multiplicity of scripters such as Ping, Pong, Query, Queryhit, Push, and the like.

Preferably, the client system may include a video game machine, such as PS2, Xbox, GameCube, PSP, PSX, N-Gage, Nintendo DS and the like in which an on-line or two-person game is possible with a separate memory.

Further, according to yet another aspect of the present invention for achieving the aforementioned objects, there is provided a method for a cooperative game including dance games applied with the method for implementing interactions between a plurality of cooperative game systems generated in the course of individually realizing unit motions of each of the cooperative game systems by applying the method for synchronizing motions in the cooperative game system of claim 1, wherein: if, with respect to an event input by one player during any one of unit times when progress is repeated in synchronization with a standard time, another player inputs the same event, each of the plurality of cooperative game system realizes a unit motion corresponding to the inputted event through the structure during a subsequent unit time, and at the same time, plays the game while allowing interactions generated by an individual unit motion implemented at each cooperative game system to be represented as a new unit motion by applying the method for synchronizing motions in the cooperative game system.

Preferably, the unit motion may have a first pose and a last pose matched to each other.

Preferably, the unit motion may have a playing time that is adjusted by tempo.

Preferably, the unit motion may include movements in eight directions of front, back, left, right, front-left, front-right, back-left, and back-right.

Preferably, the unit motion may include 90° rotation, 180° rotation, 360° rotation, and a special unit motion.

Preferably, the unit motion may include sitting, standing, bending, and successively rotating.

Preferably, the unit motion may include joints constituting a structure and motion modifications by the joints.

Preferably, the unit motion may have as one unit several joints constituting a structure and several combinations of a plurality of motions by the joints.

Preferably, processing may be made with a temporal effect by a mechanical control in a controller, or a spatial and physical effect such as a drag force and action/reaction upon controlling structure motions.

Preferably, the event may be input by one or a combination of a keyboard, mouse, joystick, key panel, dance pad, and network interface card (NIC).

Preferably, the event may be such that position values input via various sensors or cameras are input as motion data.

Preferably, the structure may be a two or three-dimensional object.

Preferably, the object may be implemented by a combination of an object made based on images input via cameras or the like, and an actual image.

Preferably, the structure may be an avatar made by a separate modeling tool.

Preferably, the system may include a separate chatting tool to exchange conversation with a party system by means of character or voice systems.

Preferably, the system may be include a video game machine, such as PS2, XBox, GameCube, PSP, PSX, N-Gage, Nintendo DS in which an on-line game or a two-or-more person-game is possible with a separate memory.

Preferably, the unit motion may be played by two persons like a sports dance.

Preferably, the sports dance may be played as one or combination of waltz, tango, fox trot, Vienna waltz, quickstep, jive, rumba, chachacha, samba, passodobbele, and blues.

Preferably, the unit motion may be made by one or combination of swing, salsa, disco, twist, mambo, hip-pop, synchronized swimming, and ice dancing.

### BRIEF DESCRIPTION OF THE DRAWINGS

The above and other objects and features of the present invention will become apparent from the following description of preferred embodiments given in conjunction with the accompanying drawings, in which:

FIGS. 1 and 2 are a schematic configuration diagram and a schematic functional block diagram, respectively, for implementing a method for synchronizing motions in a cooperative game system according to an embodiment of the present invention;

FIG. 3 is a function block diagram for implementing a method for synchronizing motions in a cooperative game system according to an embodiment of the present invention in the form of a remote client system over a network;

FIG. 4 is a flow diagram showing an overall process of synchronizing motions in a cooperative game system including dance games realized in the form of the client system of FIG. 3;

FIG. 5 is a flow diagram showing a motion input processing subroutine for a first client system as a leader in the cooperative game system including dance of FIG. 4;

FIG. 6 is a flow diagram showing a motion input processing subroutine for a second client system as a follower in the cooperative game system including dance of FIG. 4;

FIG. 7 illustrates exemplary GUI screens displayed on monitors of a first client system as a leader and a second client system as a follower, which are users, in the cooperative game system including dance of FIG. 4;

FIGS. 8 to 15 are exemplary screens displayed in the first client system as a leader while a cooperative game is being played in the cooperative game system including dance of FIG. 4; and

FIGS. 16 to 23 illustrate exemplary screens displayed in a second client system as a follower while a cooperative game is being played in the cooperative game system including dance games of FIG. 4.

### DETAILED DESCRIPTION OF THE INVENTION

Hereinafter, a method for synchronizing motions in a cooperative game system, a method for implementing interaction between a number of cooperative game systems to which the synchronizing method is applied, and a cooperative gaming method including dance games according to an embodiment of the present invention will be described in more detail with reference to the accompanying drawings.

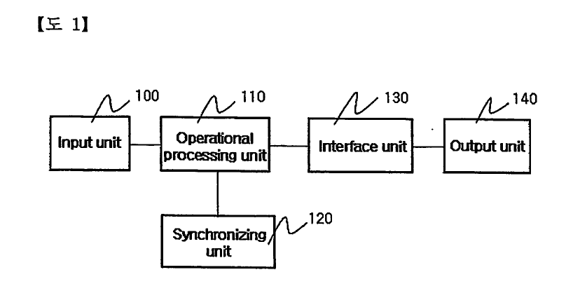

FIG. 1 is a schematic configuration diagram for implementing a method for synchronizing motions in a cooperative game system according to an embodiment of the present invention.

According to an embodiment of the present invention, the cooperative game system includes an input unit 100, an operational processing unit 110, a synchronizing unit 120, an interface unit 130, and an output unit 140. Here, a cooperative game means a game which is played while a number of structures cooperatively make one completed motion, for example, in such a manner that one step is completed while a follower follows the motion of a leader in a dance game such as a tango.

The input unit 100 generates an event selected to display a specific motion according to a user's request. This input unit 100 is a human interface and inputs data and information to the operational processing unit 110 by means of a number of keys on a computer or a portable unit. The input unit 100 may be generally implemented by one or a combination of a keyboard, mouse, trackball, joystick, touch screen, cellular phone key pad, dance pad, and network interface card (NIC).

The operational processing unit 110 includes a central processing unit, ROM, RAM, cathode ray tube (CRT) controlling unit, and controlling unit, all of which is not shown.

Here, the central processing unit (CPU) performs operation and system control by means of a control program, is composed of a micro processing unit (MPU) and the like, initiates a control program stored in ROM, and performs an operation for executing a data control process according to the control program.

The ROM is a nonvolatile memory, and stores the control program of the central processing unit.

Further, the RAM stores data or contents needed for the central processing unit to run the control program, or an operation result needed in an operation process of the central processing unit.

Further, the CRT controlling unit sequentially reads data or content stored in the RAM over a predetermined period by using an address, converts them to a video signal, and outputs the video signal to the output unit 140.

Further, the controlling unit delivers the video signal and audio signal, generated at the CRT controlling unit, to a screen output unit and a sound output unit via the interface unit 130, respectively.

The synchronizing unit 120 matches time differences between users to be same by comparing an event, generated from the input unit 100, to a standard time and correcting time differences. This synchronizing unit 120 includes an obtained time setting unit, a time synchronizing unit, a unit motion setting unit, and a unit motion synchronizing unit, all of which are not shown.

Here, the time setting unit sets a standard time for matching user times to one standard. As a method of setting a standard time, a method is used which sets a clock of an atom clock server on Internet or a server for an on-line or web service to the standard time, and which matches the user time to the standard time at a state where an on-line or Internet connection is established. On the other hand, in a case where a connection is made between devices at a state where the on-line and web connection is not established, each time or a specified time of the devices may be used as the standard time as it is.

In the case where the game system is implemented in the form of a single system as well as, particularly, in the form of a remote client system over a network, the time synchronizing unit serves to eliminate event time differences resulting from information transmission by calculating time differences due to transmission time differences caused when the server transmits information, based on the standard time set by the time setting unit and an inter-user transmission time, and by delivering the time differences via the interface unit 130 for the user. Further, the time synchronizing unit also serves to match the events to each other by re-calculating the time differences through consideration of the transmission time delay due to server load.

The unit motion setting unit allows motion playing, such as progress, rotation, and balance maintenance by classfying unit motions by joints, constituting a structure, and motions by the joints. A scheme of generating data according to proceeding with a variety of motions at this unit motion setting unit includes a calculation scheme with interpolation, a skeletal animation scheme, and a bone animation or skinning animation scheme. The scheme with interpolation (i.e., vertex animation or key frame animation) is a scheme in which each vertex position and related data in a frame corresponding to a scene by each motion are stored and then are calculated by linear interpolation or other interpolations. The skeletal animation is a scheme in which a structure is divided into several substructures, each relationship therebetween is defined, and data including movement, reduction, and rotation of each divided substructure is stored and used every frame or varying frame. The bone animation is a scheme in which a hierarchical structure is included which defines each relationship based on structure data for a joint unit called a bone, and movement is made with a position value. Using the bone animation scheme enables data to be generated from motions based only on smooth motions and less data files.

The unit motion synchronizing unit allows inter-structure events and motion occurrences to be simultaneously implemented based on a time synchronized to each user on a basis of the set standard time, in order to consider interactions between one structure and another structure remotely connected between the users.

That is, the unit motion synchronizing unit compares an event occurred by the input of a leading input person to an event occurred by the input of a subsequent input person, based on a time synchronized to each user on the basis of the set standard time that can be variously input by a number of users, to determine whether two inputs are matched to each other, so that simultaneity of motion occurrences is implemented.

For this unit motion synchronizing unit to match the unit motions, it is possible to additionally use sound, if necessary, and at this time, usage sound includes WAV, MP3, WMA, MIDI and similar types of sound. In this case, it is possible to match motion flow to sound rhythm, and also to set a standard time by fitting a time progress in the sound and match it to the unit motion.

The interface unit 130 interfaces the central processing unit, the ROM, the RAM, and the CRT controlling unit in the operational processing unit 110 to an input unit, a memory unit, and a display unit, which are external devices, so that the video and the sound are output according to events synchronized to the standard time.

The output unit 140 outputs video and audio data. The output unit 140 allows transmitted and received data in a computer and a portable unit and the control or not of the data to be displayed on a screen of an image display device, such as a monitor, a head up display (HUD) device, an LCD panel, and the like, and allows input/output intermediation states to be confirmed by outputting a sound signal via a speaker or the like. Alternatively, the output unit 140 allows input/output intermediation states to be confirmed through a separate device that outputs audio and video data.

A motion synchronizing operation of the cooperative game system configured as described above according to an embodiment of the present invention will be described.

First, the synchronizing unit 120 sets a standard time by using one of the aforementioned methods.

The synchronizing unit 120 also sets a unit motion that moves during a unit time. In a forward walking motion, an initial pose and a final pose in an arbitrary unit time are basic poses, and a unit motion for walking is carried out in the unit time period.

For example, if a user inputs a walking motion event via the input unit 100, the operational processing unit 110 allows the event to be output at the output unit 140 via the interface unit 130 so that the structure performs a walking motion for the relevant unit time period in synchronization with a subsequent unit time from the input instant by the synchronizing unit 120. An event input by the user at an arbitrary instant within the unit time period when the structure is performing the walking motion is applied and is carried out to the structure during a next unit time.

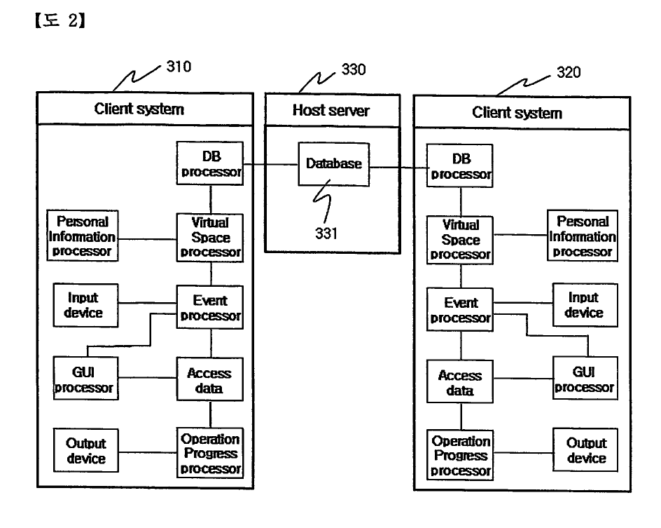

FIG. 2 is a schematic functional block diagram for implementing a method for synchronizing motions in a cooperative game system according to an embodiment of the present invention.

First, the input unit 100 comprises an input device 101. The input device 101 is a human interface, such as a keyboard, mouse, joystick, key panel, and dance pad, and generates an event by means of a number of keys on a computer or a portable unit. Further, the input device 101 may have a form, such as a direct input of motions via cameras or sensors, a command input by voice input such as a microphone, or an input by a network interface card (NIC).

The synchronizing unit 120 comprises a DB processor 121, a virtual space processor 122, and a personal information processor 123.

Here, the DB processor 121 makes a database for users' records, such as logged history, scores, and levels, in the form of data that may be included or separately added to the computer or portable unit, so that the present system retrieves the records, if necessary.

The virtual space processor 122 stores a virtual space in a RAM of the operational processing unit 110 when the system is initiated, adjusts the virtual space according to a user's event input in use, and erases the virtual space in the RAM when the system is terminated.

The personal information processor 123 is a module for processing the task of authenticating user's personal information when the system is initiated and storing the personal information when the system is terminated, in which the processing is made through network communication with a host server.

The operational processing unit 110 comprises an event processor 111, an access data processor 112, and a graphic user interface (GUI) processor 113.

Here, the event processor 111 converts user input data from the input device 101, to access data according to the progress of the GUI processor 113.

The access data processor 112 is composed of an access data transmitter and an access data determiner. The access data transmitter sends the access data, which has been produced by the event processor 111, to another client and accepts access data from another client. The access data determiner performs comparison of a time, which is a given condition, to required data and sends a comparing result to the interface unit 130.

The GUI processor 113 allows the user to monitor, via the output unit 140, various situations progressed by the present system, and also serves to indicate a time point when the user must generate an event.

The interface unit 130 comprises a motion progress processor 131. The motion progress processor 131 enables the unit motion set by the synchronizing unit 120 to be carried is out at each client by using information delivered from the access data processor 112.

The output unit 140 comprises an output device 141, and the output device 141 outputs the unit motion that has been processed by the motion progress processor 131, accompanied by the screen and the sound.

FIG. 3 is a function block diagram for implementing a method for synchronizing motions in a cooperative game system according to an embodiment of the present invention in the form of a remote client system over a network.

According to an embodiment of the present invention, the cooperative game system may be implemented in a server/client (S/C) scheme in which two client systems 310 and 320 and a host server 330 are interconnected, as shown in FIG. 3. Alternatively, the system may be implemented by a peer-to-peer (P2P) scheme. Alternatively, the system may be implemented by a video game machine scheme, such as PS2, XBox, GameCube, PSP, PSX, N-Gage, and Nintendo DS in which an on-line game or a two-or-more-person game is possible with a separate memory.

A difference between the S/C scheme and the P2P scheme is caused from the number of connected users. The S/C scheme is applied to a case where a greater number of users desire to be connected while the P2P scheme is applied to a case where only a few users are considered.

In the S/C scheme, the host server manages a database, and processes information between persons through information processing by each client system. Event processing between respective remote client systems becomes possible based on the database in the host server and access data is shared between the client systems through access data processing.

On the other hand, in the P2P scheme, two client systems process and then share personal information therebetween without a host server. In this P2P scheme, real-time communication or resource distribution for both an information sharing type and a resource sharing type are possible, and scripters such as Ping, Pong, Query, Queryhit, Push, and the like are allowed to be freely used. Further, in the video game machine, such as PS2, XBox, GameCube, PSP, PSX, N-Gage, and Nintendo DS, since the machine has a separate memory, managing the database and sharing access data between parties are possible on the memory.

Each of the client systems includes the cooperative game system as shown in FIG. 2, and includes a structure moved by the event input from the input device, and a structure moved by an event input from another client system.

That is, as shown in FIG. 3, in the case where two client systems are interconnected, two structures are displayed on the screen of the output unit of each of the client systems, one moving in response to the user event input from its own input device and the other moving in response to an event input from the party client system.

Two client systems are synchronized to a standard time, and a unit motion according to a relevant event for the next unit time is executed by an event input for a unit time set at uniform intervals.

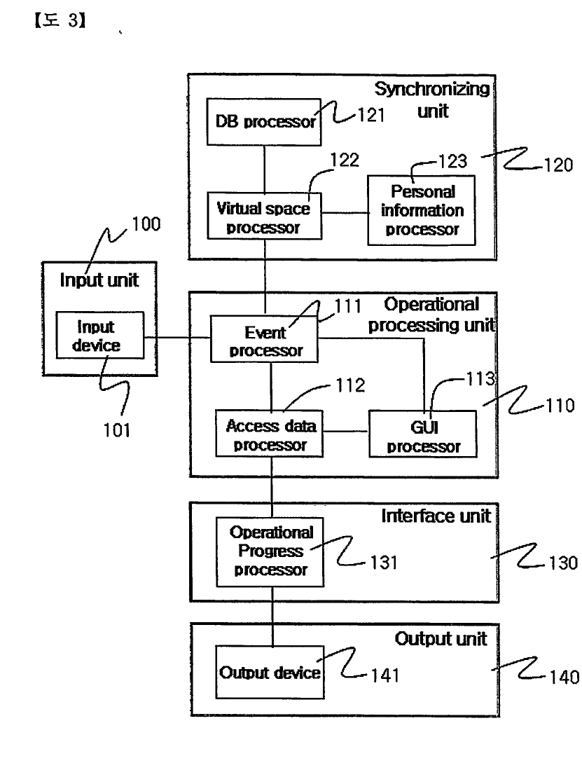

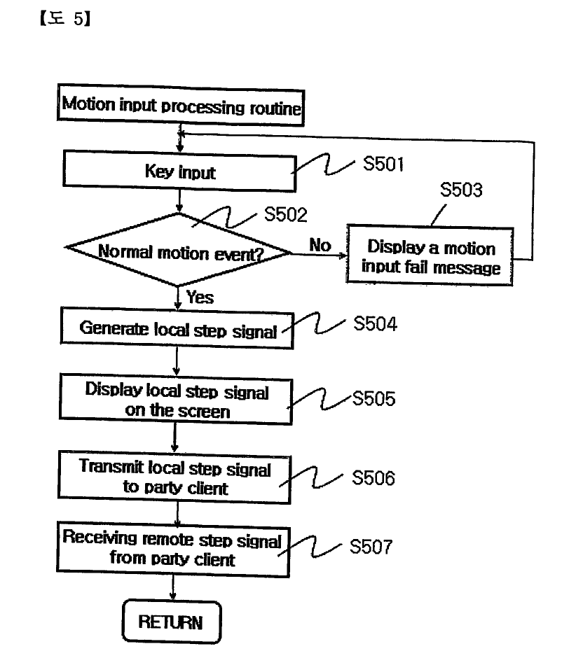

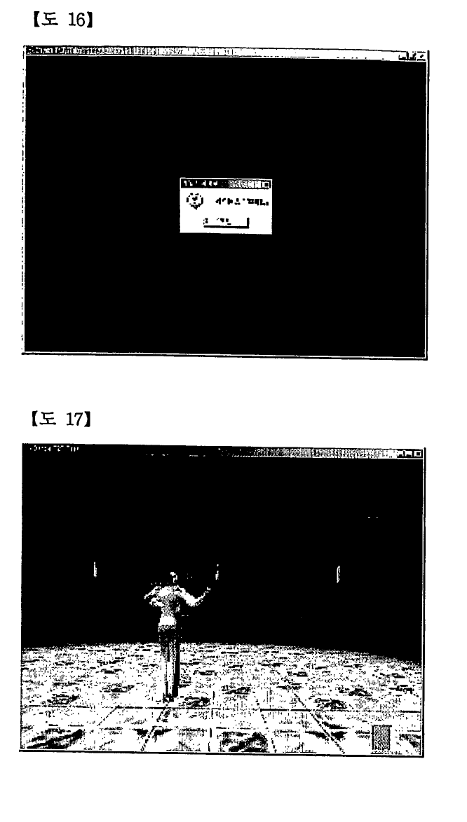

FIGS. 4 to 6 are flow diagrams showing a process of synchronizing motions in a cooperative game system including dance games, which is realized in the form of the client system of FIG. 3, and FIGS. 7 to 23 are exemplary screens displayed on the monitor of the cooperative game system including dance of FIG. 4.

For convenience of illustration, it is assumed that the gaming method of FIGS. 4 to 6 is a cooperative gaming method including dance implemented in the P2P scheme.

It is also assumed that a first player plays the game using a first client system and a second player uses a second client system, in which the first player is a leader and the second player is a follower.

When the standard time is divided into a number of unit time periods (World Time Code: WTC) set at uniform intervals, respective players input a motion event in an arbitrary unit time period. The input motion event is sent to the party client system over the network, and a motion corresponding to the motion event is displayed on the screen during a next unit time period (WTC).

It is assumed that a motion event directly input by a player is a local step signal, and a motion event input from a party client system is a remote step signal.

That is, in the case of the first client system, the motion event input by the first player is a local step signal, and a motion event input from the second client system is a remote step signal. In the case of the second client system, the motion event directly input by the second player is a local step signal, and the motion event input from the first client system is a remote step signal.

FIG. 7 is an exemplary diagram of a GUI screen displayed on a monitor of a user. A step image 71 indicating stage background where dancing is shown and the step signals, a structure (character) 72 at a screen center portion, a unit motion input fail accumulating number or a success accumulating number 73, and a time gauge 74 are displayed on the user GUI screen. This time gauge 74 is a time when a unit motion can be input and indicates the elapsed time and remaining time in the present WTC.

FIG. 4 is a flow diagram showing an overall process of synchronizing motions in a cooperative game system including dance games that is realized in the form of the client system of FIG. 3.

First, if a game starts, a client system is synchronized to a party client system (S401).

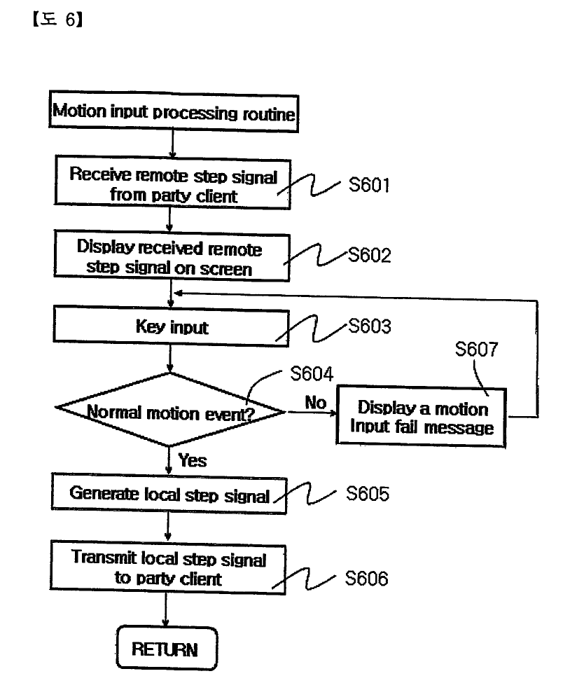

FIGS. 8 to 11 and FIGS. 16 to 19 are exemplary screens for a synchronizing process.

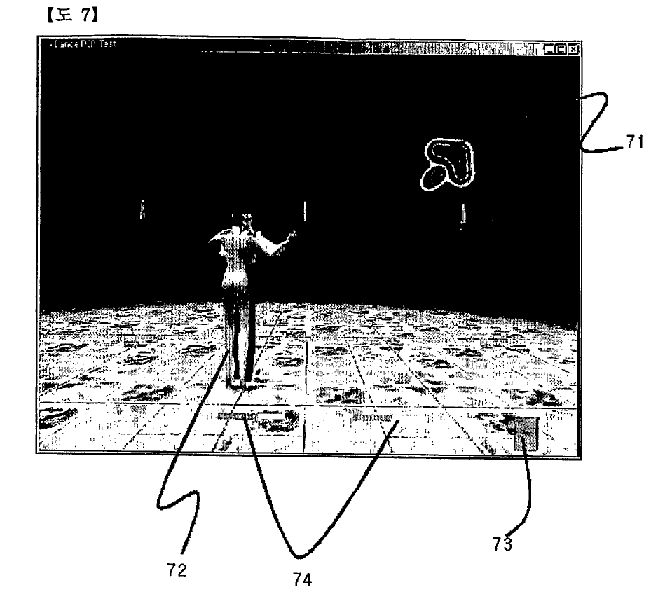

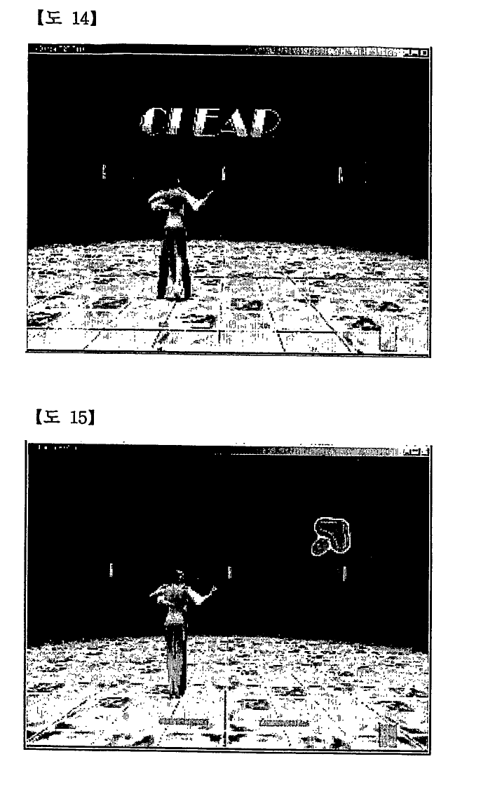

First, a conversation window, on which players confirm the game start, is displayed on respective client systems, as in FIGS. 8 and 16. If each of the players clicks on a confirmation button on this conversation screen, a background screen and a structure are displayed, as in FIGS. 9 and 7, and a client system waits to receive a synchronization signal from the party client system. If the synchronization signals are communicated between the two client systems, the client systems are switched to a service ready state for the cooperative game including dance games, as in FIGS. 10 and 18.

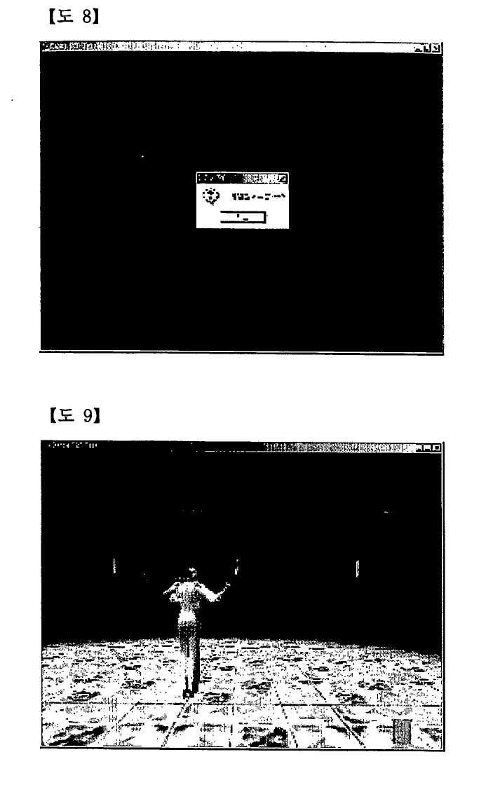

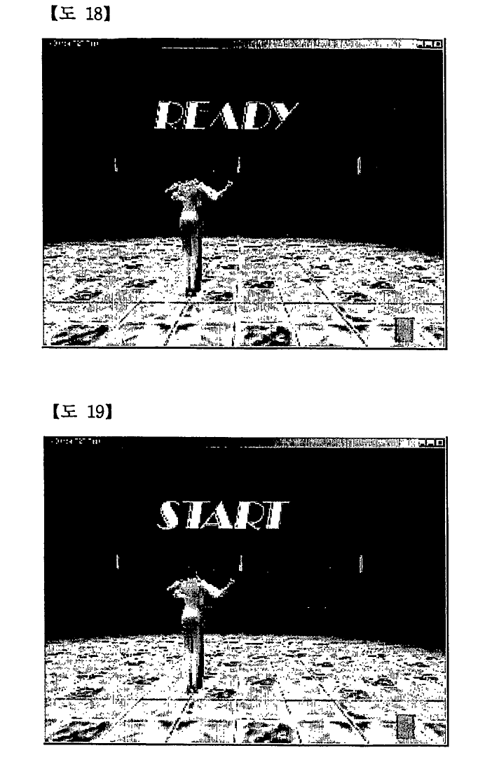

If the cooperative game including dance games starts and one arbitrary unit time period WTC_i is initiated, as in FIGS. 11 and 19 (S402), a motion input ready state is displayed on the screen (S403). When the WTC_i is initiated, a remaining time is displayed on all the systems. As the time elapses, it is displayed that an elapsed time increases and the remaining time decreases.

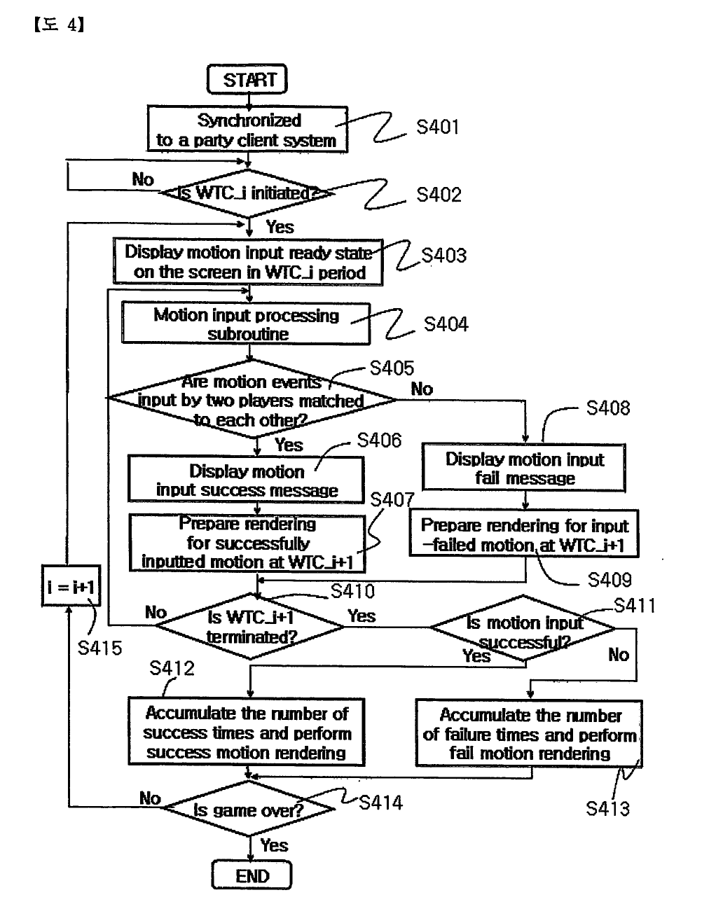

A motion input processing subroutine is executed during a time period when a unit motion is allowed to be input (S404). Each player inputs a motion event while this motion input processing subroutine is being executed. If a first player as a leader first inputs a motion event, the step signal input by the first player is displayed to the first and second client systems. If a second player views the step image displayed on the screen and inputs a motion event, the step signal input by the second player is delivered to the first client system. Detail descriptions on this motion input processing subroutine will be described below with reference to FIGS. 5 and 6.

That is, after the motion input processing subroutine (S404) is normally executed, each client system will have the local step signal according to the motion event directly input by the player and the remote step signal input from the party client system.

Following the motion input processing subroutine (S404), it is checked whether the motion events input by two players match each other (S405).

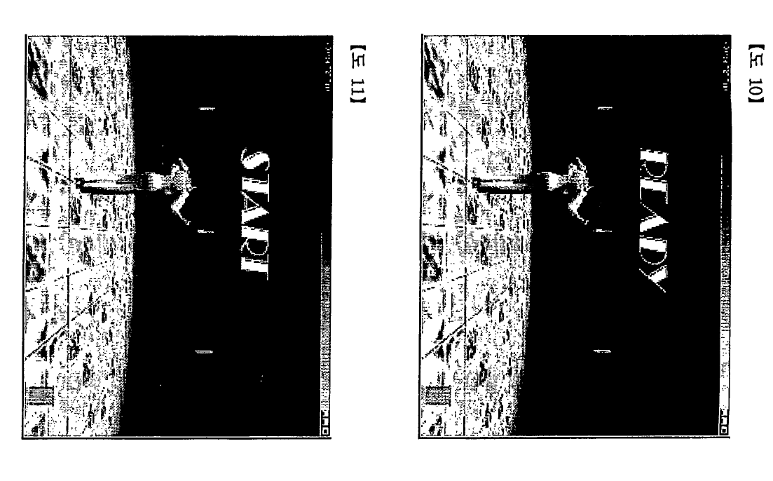

If it is checked at S405 that the motion events input by the two players match each other, a motion input success message is displayed on the screen as in FIGS. 13 and 21 (S406), and rendering for the successfully input motion is prepared (S407).

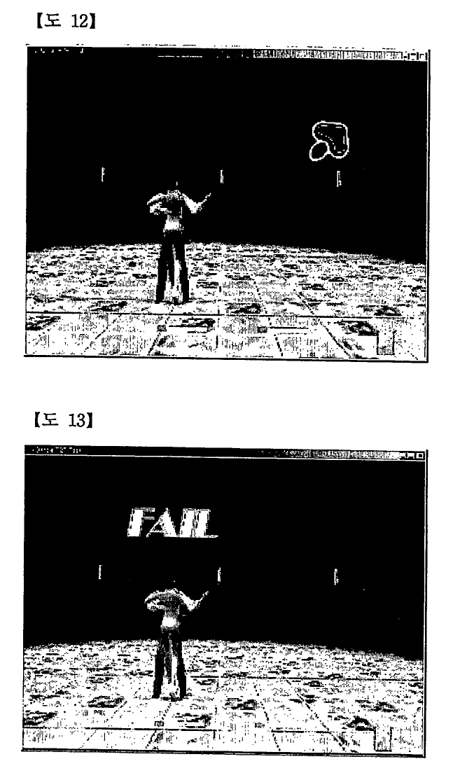

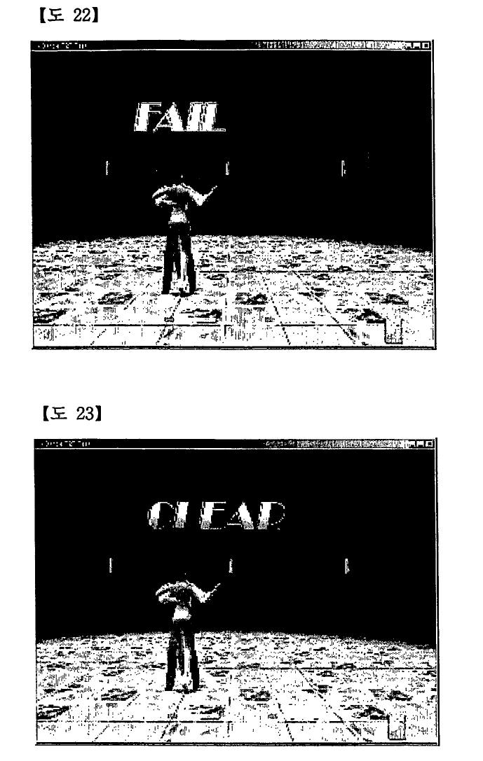

On the other hand, if it is checked at S405 that the motion events input by two players do not match each other, a motion input fail message is displayed on the screen as in FIGS. 14 and 22 (S408), and rendering for the input-failed motion is prepared (S409). This rendering for the input motion is processed in a WTC_i+1 period.

If the WTC_i period is not terminated (S410), the motion input processing subroutine S404 may be re-executed when the motion input fails.

If the WTC_i section is terminated (S410), it is determined whether the motion input is successful (S411). If it is successful, the number of success times is accumulated and success motion rendering is performed (S412), and if the motion input fails, the number of failure times is accumulated and the fail motion rendering is performed (S413).

It is then determined whether the game is over. If the game is not over, i is incremented by 1 (S415) and then process is returned to S403. Strictly speaking, although the successful motion rendering and the failed motion rendering in S412 and S413 are processed while S403 to S409 are being processed in the WTC_i+1 period, they are separately illustrated in this embodiment to assist in understanding the present invention.

The aforementioned cooperative game including dance games is over when the background music for the dance service is played out or the number of the accumulative fail times exceeds the prescribed number of times. If the background music is played out in a state where the number of the accumulative fail times does not exceed the prescribed number of times, a dance game clear screen is output, as in FIGS. 15 and 23.

FIG. 5 is a flow diagram showing a motion input processing subroutine for a first client system as a leader in the cooperative game system including dance of FIG. 4.

If there is a key input from the first player (S501), it is checked whether the relevant key input is a normal motion event (S502).

If it is not the normal motion event, a motion input fail message is displayed on the screen (S503) and the process returns to S501.

If the normal motion event is input at S502, the first client system generates a local step signal (S504), displays the relevant local step signal on the screen as in FIG. 12 (S505), and transmits the local step signal to the second party client system (S506). When receiving the remote step signal from the second party client system, the first client system returns to S405 (S507).

FIG. 6 is a flow diagram showing a motion input processing subroutine for a second client system as a follower in the cooperative game system including dance of FIG. 4.

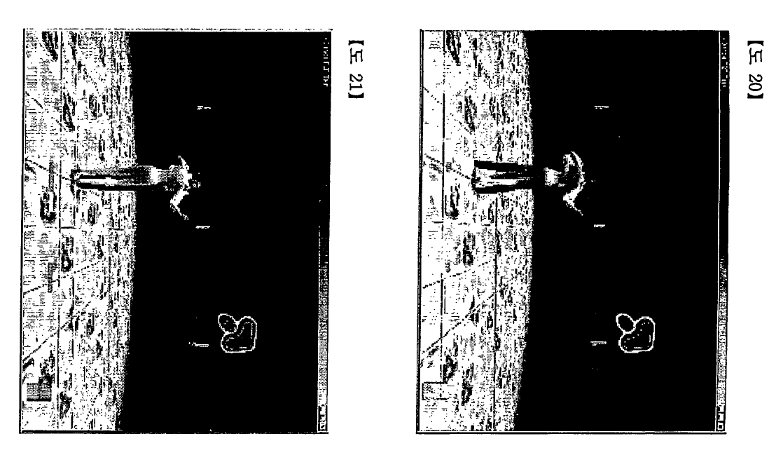

When receiving a remote step signal from the first party client system (S601), the second client system displays the received remote step signal on the screen as shown in FIG. 20 (S602) and waits to receive a key input from the second player.

If there is the key input (S603), it is checked if the relevant key input is a normal motion event (S604). If it is the normal motion event, the second client system generates a local step signal (S605), sends the generated local step signal to the first party client system, and then returns to S405 (S606). On the other hand, if it is not the normal motion event (S604), the second client system displays the motion input fail message on the screen (S607) and then returns to S603.

Although only two clients are shown as being connected to one host server in FIG. 3, more client systems can be connected thereto. In the case where a number of client systems are connected as such, interactions may occur between a number of cooperative game systems when a number of cooperative game systems play a game while individually implementing respective unit motions in one stage.

For example, although a number of cooperative game systems individually implement respective unit motions, a case may occur in which the unit motions collide with each other in this implementing process, which makes it difficult to implement a correct unit motion.

If, with respect to an event input by one player during any one of unit times in which progress is repeated in synchronization with the standard time, another player inputs the same event, each of the number of cooperative game systems realizes the unit motion corresponding to the input event through the structure during a subsequent unit time, and at the same time, allows interactions occurred by an individual unit motion implemented in each cooperative game system to be represented as a new unit motion, which is reflected to naturally solve the interactions by applying the aforementioned method for synchronizing motions in a cooperative game system.

That is, it is allowed to enjoy the cooperative game generally full of reality sense on a virtual space implemented through connection of a number of client systems on various on-lines and webs, by synchronizing a number of client systems to the standard time, transmitting events generated by each of a number of client systems to party clients, synchronizing events generated during the certain reference period to the standard time, displaying an input event from a previous input client and an input event from a subsequent input client on the screens of relevant clients via a GUI, and displaying motions of one structure on the screens, in which one unit motion is realized according to whether the input events from the relevant clients match each other and at the same time, the game is played as one form by the interactions according to the unit motions realized by input events from other clients.

In the case of the cooperative game including dance according to an embodiment of the present invention, two structures (characters) are coupled to face each other, players move the structure through the unit motion having eight directions of front, back, left, right, front-left, front-right, back-left, and back-right, and the structure has twelve unit motions, including 90° rotation, 180° rotation, 360° rotation, and a separate special unit motion, in addition to the eight unit motions. A time taken to perform one unit motion ranges from WTC 1 unit to WTC 4 units, and a first pose and a last pose of the unit motion are set to be matched to each other in order to make a pose of connecting respective unit motions smooth. Although the unit motion has been described herein only on the direction to assist in understanding the present invention, one unit motion may include several joints making up the structure in one unit motion and several motion modifications by the joints (e.g., a number of motion combinations such as lifting one arm up, shaking the arm a circle, bending and spreading the arm, lifting and then taking the arm down, and the like, or a number of motions combination according to directions, and arm and leg movements by key inputs independent of the directions).

If the game starts, the first client system (leader) sends a WTC_i synchronization signal to the second client system (follower) as a playing time of the background music elapses. Each client system displays a step image corresponding to a motion event, inputted from the first player, as a hollow state during the unit time period WTC_i.

If the motion events input by the first player and the second player match each other after the unit time period, the client system may display it in a fully filled state, display that a motion according to input success for a next unit time period, WTC_i+1, is proceeding or that connection of the motions is successful, by adding a point, and display it by means of, for example, a blue lamp, OK or success on the screen, if necessary.

However, if the motions input by the first player and the second player do not match each other after the unit time period, a motion according to the input fail proceeds in the next unit time period, WTC_i+1, and unit motion input fail is displayed on the output unit.

If such non-match between motion inputs occurs or is accumulated, the played game may be stopped, or point reduction, red lamp indication, or a message such as fail may be displayed on the screen. Alternatively, such information can be output through acoustic or voice methods other than screen output.

At the last frame of the unit motion, the structure moves to a position of the last pose and starts with a next unit motion. This is for solving a problem that an individual motion (a position that a foot reaches, and the like) taken by a model, such as a dance motion, a fighting motion, or the like, cannot be individually matched to the virtual space because the model or the like (object) moves in a constant speed and a constant direction if a movement of the object is handled as a velocity vector in the virtual space.

Although the embodiment of the present invention has described that the first pose and the last pose of the dance unit motion are exactly matched to each other, this is only one example and the first pose and the last pose may not match each other. Further, it is possible to adjust a tempo of the playing time of the unit motion, if necessary.

Further, according to an embodiment of the present invention, it is possible to implement a cooperative game including dance with a certain format by additionally displaying a series of step images on the screen of the player.

Further, although the embodiment of this invention limits the number of the unit motions to twelve, it is possible to add or modify motions in the form of, for example, sitting, standing, bending, and continuously rotating according to the type of the dances, in addition to the twelve unit motions.

Further, although it has been described that inputs are made by the input unit such as a keyboard, mouse, joystick, key panel, dance pad, and network interface card (NIC), a method of obtaining a position value by using various attached sensors or cameras for conjunction with virtual reality is possible. Alternatively, for an object to input motion data through combination, parallelism, and the like is possible.

Further, although a model used in the client uses a typical two or three-dimensional object as an object, it is possible to implement the model through an avatar made by a separate modeling tool or through connection between an object, based on an image input via cameras or the like, and a real image.

Further, it is possible to exchange conversation with parties through characters or voice by using a chatting tool, such as a messenger independent of the input unit.

Further, although it has been described that the output unit outputs motions via a monitor or the like, it is possible to adjust one or more coupled object via wired or wireless transmission and reception to and from a solid object (e.g., animal, robot, airplane, or the like, including humans).

The present invention is not limited to the aforementioned embodiments and may be carried out in several forms.

That is, the present invention is applicable to a three-legged game, or a variety of application games in which one structure must be formed and operated by two or more persons. For example, the present invention can be applied to a game that needs synchronization to a structure's unit motion and that requires balance maintenance, such as a Chinese lion game, a game with balance-requiring motions being applied, such as rope dancing, ball rolling, and human tower building by two or more persons, which may be found in a circus or a feat performance, a game in which a temporal or spatial effect by a mechanical control in a controller (i.e., an effect according to in-the-air, in-the-water, drag force and action/reaction in a space, etc.) is not handled as a simple time delay but is handled including physical effects upon controlling structure motions in a one-person simulation game, or the like.

Further, the present invention can be applied to a game played by two persons, such as a sports dance. The sports dance can be played as motions by one or a combination of Latin five events, such as jive, rumba, chachacha, samba and passodobbele, and blues, swing, salsa, disco, twist, mambo, hip-pop, synchronized swimming, and ice dancing, in addition to modern five events, such as waltz, tango, fox trot, Vienna waltz, and quickstep.

Further, although the embodiment of the present invention has illustrated the case where there are two players, the present invention is not limited thereto. That is, the present invention can be applied to a case where there are multiple players.

Likewise, although the embodiment of the present invention has illustrated the case where two structures are played as one form by interactions, the present invention can be applied to multiple structures that are configured of one or more forms.

An example of the aforementioned source program according to the present invention is as follows.

According to the present invention as described above, in three-dimensionally realized computer graphics images, free representation for structure motions is possible, as well as structure motions that consider interactions between structures having a plurality of links can be realized by simpler and easier manipulations.

Further, according to the present invention, physical characteristics similar to reality can be realized on structure motions provided through three-dimensional graphics images, and an overall structure can operate successively while maintaining natural poses.

1. A method for synchronizing motions realized in a game system including dance games played through cooperation between players, wherein:
if, with respect to an event input by one player during any one of unit times when progress is repeated in synchronization with a standard time, another player inputs the same event, a unit motion corresponding to the input event is simultaneously represented through the structure during a subsequent unit time.

2. The method as claimed in claim 1, wherein the cooperative game system is implemented in the form of a single system.

3. The method as claimed in claim 1, wherein the cooperative game system is implemented in the form of a remote client system over a network.

4. The method as claimed in claim 1, wherein the event is input by one or a combination of a keyboard, mouse, trackball, joystick, touch screen, cellular phone key pad, dance pad, and network interface card (NIC).

5. The method as claimed in claim 1, wherein the event is input by a direct action input device with cameras or sensors and a voice input device such as a microphone.

6. The method as claimed in claim 1, wherein the standard time is set as a world time code (WTC).

7. The method as claimed in claim 1, wherein the unit motion is set while storing frame vertex positions and data that correspond to respective motion scenes and producing data through interpolation calculations.

8. The method as claimed in claim 1, wherein the unit motion is set while dividing the structure into several substructures, defining each relationship for the substructures, and producing data by specifying data for the divided substructures every frame or varying frame.

9. The method as claimed in claim 1, wherein the unit motion is set while producing data through movement along position values in a hierarchical structure that defines respective relationships based on structure data of a joint unit called a bone.

10. The method as claimed in claim 1, wherein the unit motion additionally use sound and is displayed in synchronization with the sound.

11. The method as claimed in claim 10, wherein the sound is one of WAV, MP3, WMA or MIDI format.

12. The method as claimed in claim 10, wherein the unit motion is displayed in synchronization with a standard time, the standard time being set in conformity with a playing time of the sound.

13. The method as claimed in claim 1, wherein the unit motion is outputted and displayed via an image output device and a sound output device.

14. The method as claimed in claim 13, wherein the image output device is any one of a monitor, a head up display device (HUD), or an LCD panel.

15. The method as claimed in claim 13, wherein the sound output device is a speaker.

16. The method as claimed in claim 1, wherein the image output device confirms input/output intermediation states via a solid object based on transmission and reception to and from the solid object.

17. A method for implementing interactions between a plurality of cooperative game systems generated in a course of individually realizing unit motions of each of the cooperative game systems by applying the method for synchronizing motions in the cooperative game system of claim 1, wherein:
if, with respect to an event input by one player during any one of unit times when progress is repeated in synchronization with a standard time, another player inputs the same event, each cooperative game system realizes a unit motion corresponding to the input event through the structure during a subsequent unit time, and at the same time, allows interactions generated by an individual unit motion implemented on each cooperative game system to be represented as a new unit motion by applying the method for synchronizing motions in the cooperative game system.

18. The method as claimed in claim 17, wherein the standard time is set as a world time code (WTC).

19. The method as claimed in claim 17, wherein the plurality of cooperative game systems are implemented in the form of server/client by one server system and a plurality of client systems.

20. The method as claimed in claim 17, wherein the plurality of cooperative game systems are implemented in the form of peer to peer by a plurality of client systems.

21. The method as claimed in claim 20, wherein the peer-to-peer form is serviced via one or a combination of an information sharing types and resource sharing types.

22. The method as claimed in claim 20, wherein the peer-to-peer form uses one or multiplicity of scripters such as Ping, Pong, Query, Queryhit, Push, and the like.

23. The method as claimed in claim 20, wherein the client system includes a video game machine such as PS2, XBox, GameCube, PSP, PSX, N-Gage, Nintendo DS and the like in which an on-line or two-person game is possible with a separate memory.

24. A method for a cooperative game including dance games applied with the method for implementing interactions between a plurality of cooperative game systems generated in the course of individually realizing unit motions of each of the cooperative game systems by applying the method for synchronizing motions in the cooperative game system of claim 1, wherein:
if, with respect to an event inputted by one player during any one of unit times when progress is repeated in synchronization with a standard time, another player inputs the same event, each cooperative game system realizes a unit motion corresponding to the inputted event through the structure during a subsequent unit time, and at the same time, plays the game while allowing interactions generated by an individual unit motion implemented on each cooperative game system to be represented as a new unit motion by applying the method for synchronizing motions in the cooperative game system.

25. The method as claimed in claim 24, wherein the unit motion has a first pose and a last pose matched to each other.

26. The method as claimed in claim 24, wherein the unit motion has a playing time that is adjusted by tempo.

27. The method as claimed in claim 24, wherein the unit motion includes movements in eight directions of front, back, left, right, front-left, front-right, back-left, and back-right.

28. The method as claimed in claim 27, wherein the unit motion includes 90° rotation, 180° rotation, 360° rotation, and a special unit motion.

29. The method as claimed in claim 27, wherein the unit motion includes sitting, standing, bending, and successively rotating.

30. The method as claimed in claim 27, wherein the unit motion includes joints constituting a structure and motion modifications by the joints.

31. The method as claimed in claim 27, wherein the unit motion has as one unit several joints constituting a structure and several combinations of a plurality of motions by the joints.

32. The method as claimed in claim 30, wherein processing is made with a temporal effect by a mechanical control in a controller, or a spatial and physical effect such as a drag force and action/reaction upon controlling structure motions.

33. The method as claimed in claim 24, wherein the event is input by one or a combination of a keyboard, mouse, joystick, key panel, dance pad, and network interface card (NIC).

34. The method as claimed in claim 24, wherein the event is such that position values input via various sensors or cameras are input as motion data.

35. The method as claimed in claim 24, wherein the structure is a two or three-dimensional object.

36. The method as claimed in claim 35, wherein the object is implemented by a combination of an object made based on images input via cameras or the like, and an actual image.

37. The method as claimed in claim 24, wherein the structure is an avatar made by a separate modeling tool.

38. The method as claimed in claim 24, wherein the system includes a separate chatting tool to exchange conversation with a party system by means of character or voice systems.

39. The method as claimed in claim 24, wherein the system includes a video game machine such as PS2, XBox, GameCube, PSP, PSX, N-Gage, Nintendo DS in which an on-line game or a two-or-more person-game is possible with a separate memory.

40. The method as claimed in claim 24, wherein the unit motion is played by two persons like a sports dance.

41. The method as claimed in claim 40, wherein the sports dance is played as one or combination of waltz, tango, fox trot, Vienna waltz, quickstep, jive, rumba, chachacha, samba, passodobbele, and blues.

42. The method as claimed in claim 24, wherein the unit motion is made by one or combination of swing, salsa, disco, twist, mambo, hip-pop, synchronized swimming, and ice dancing.
